(19) United States
(12) Patent Application Publication
(10) Pub. No.: US 2014/0137959 A1
(43) Pub. Date: May 22, 2014

(54) FUEL SUPPLY DEVICE AND FUEL-RETURNING THREE-WAY PIPE THEREOF

(71) Applicant: SHEN'S GLORY INC., Taipei City (TW)

(72) Inventor: WU-FANG SHEN, Taipei City (TW)

(73) Assignee: SHEN'S GLORY INC., Taipei City (TW)

(21) Appl. No.: 14/071,669

(22) Filed: Nov. 5, 2013

(30) Foreign Application Priority Data
Nov. 22, 2012 (TW) 101222629

(51) Int. Cl. F02M 37/00

(52) U.S. Cl. CPC F02M 37/0052
USPC 137/544; 137/602

(57) ABSTRACT

A fuel supply device connects a fuel tank, which stores a fuel necessary for power of an engine, to a hand-operating pump inlet of the engine, connects an inlet opening of a filter can that includes the inlet opening and an outlet opening to a hand-operating pump outlet of the engine, connects the outlet opening to a slope terminal of a fuel-returning three-way pipe, connects a priority terminal of the fuel-returning three-way pipe to a fuel return port of the engine, and connects a discharge terminal of the fuel-returning three-way pipe to a high-pressure pump fuel inlet port of the engine, whereby heated fuel from the fuel return port of the engine is supplied, with priority, through the discharge terminal of the fuel-returning three-way pipe to the engine for combustion for saving energy and effectively improving operation performance of the engine.

### (a) TECHNICAL FIELD OF THE INVENTION

The present invention generally relates to an automobile part, and more particularly to a fuel supply device and a fuel-returning three-way pipe thereof.

### (b) DESCRIPTION OF THE PRIOR ART

In the progress of living technology of human beings, automobiles are undoubtedly a measure that satisfies people's desires of efficient transportation and also suits people's need for comforts of travelling. In the early days, air pollution caused by the operations of automobiles was generally not an issue of concern and improvement of automobile performance has not been taken seriously for achieving the goal of green energy and environmental protection.

Recently, with the development of a trend for protecting the global environment, it is becoming an issue concerning green energy trend of the development of automobiles to reduce air pollution caused by automobiles and to improve the operations of the automobiles for reducing consumption of energy resources. With the resources of fossil energy being gradually consumed up, people are now more interested in reducing fuel consumption and improving operation efficiency. Thus, all the manufacturers of the industry are devoted themselves in developing technology and solutions for reducing fuel consumption and improving operation efficiency.

### SUMMARY OF THE INVENTION

In view of the above issues, an object of the present invention is to provide a fuel supply device and a fuel-returning three-way pipe thereof, wherein heated fuel returning from an engine is effectively utilized to achieve the purposes of saving energy and improving engine operation efficiency.

To achieve the above and other objects, the present invention provides a fuel supply device, which is fit to supply a fuel necessary for the power of an engine. The engine comprises a hand-operating pump inlet, a hand-operating pump outlet, a high-pressure pump fuel inlet port, and a fuel return port. The fuel supply device comprises: a fuel tank, a filter can, and a fuel-returning three-way pipe.

The fuel tank is connected to the hand-operating pump inlet of the engine to store the fuel necessary for the power of the engine. The filter can comprises an inlet opening and an outlet opening. The inlet opening is connected to the hand-operating pump outlet of the engine. The fuel-returning three-way pipe comprises a priority terminal, a slope terminal, and a discharge terminal. The priority terminal is connected to the fuel return port of the engine. The slope terminal is connected to the outlet opening of the filter can. The discharge terminal is connected to the high-pressure pump fuel inlet port of the engine to supply, with priority, heated fuel from the engine the fuel return port through the discharge terminal to the engine for combustion for saving energy and effectively improving operation performance of the engine.

The fuel-returning three-way pipe comprises: a three-way pipe body and a core fitting. The three-way pipe body comprises the priority terminal, the slope terminal, and the discharge terminal discussed above. A straight passage is formed between the priority terminal and the discharge terminal. The slope terminal forms a slope passage that forms an angle with respect to the straight passage. The core fitting comprises a connection end and a passage end. The connection end is inserted into and connected to the priority terminal of the three-way pipe body. The passage end has an outside diameter that is smaller than an inside diameter of the straight passage. The passage end is arranged to extend, in a direction toward the discharge terminal of the three-way pipe body, beyond the slope passage of the slope terminal.

In the instant embodiment, the three-way pipe body of the fuel-returning three-way pipe of the fuel supply device comprises a Y-shaped body and three pipe fittings. The Y-shaped body comprises a first end, a second end, and a third end. The three pipe fittings are respectively connected to the first end, the second end, and the third end of the Y-shaped body to form the priority terminal, the slope terminal, and the discharge terminal of the three-way pipe body. The angle formed between the straight passage and the slope passage of the three-way pipe body is preferably between 30 and 60 degrees.

In summary, the present invention provides a fuel supply device and a fuel-returning three-way pipe thereof; wherein returned heated fuel from an engine is supplied, with priority, to the engine for effective recovery and reuse and for avoiding any evaporation and waste of the heated fuel in the recovery process so that it is possible to achieve both saving of energy and improvement of operation performance of engine.

The foregoing objectives and summary provide only a brief introduction to the present invention. To fully appreciate these and other objects of the present invention as well as the invention itself; all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view illustrating the relationship of connection of a fuel supply device according to a preferred embodiment of the present invention.

FIG. 2 is a perspective view showing a fuel-returning three-way pipe of FIG. 1.

FIG. 3 is a cross-sectional view showing the fuel-returning three-way pipe of FIG. 1.

FIG. 4 is an exploded view showing the fuel-returning three-way pipe of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

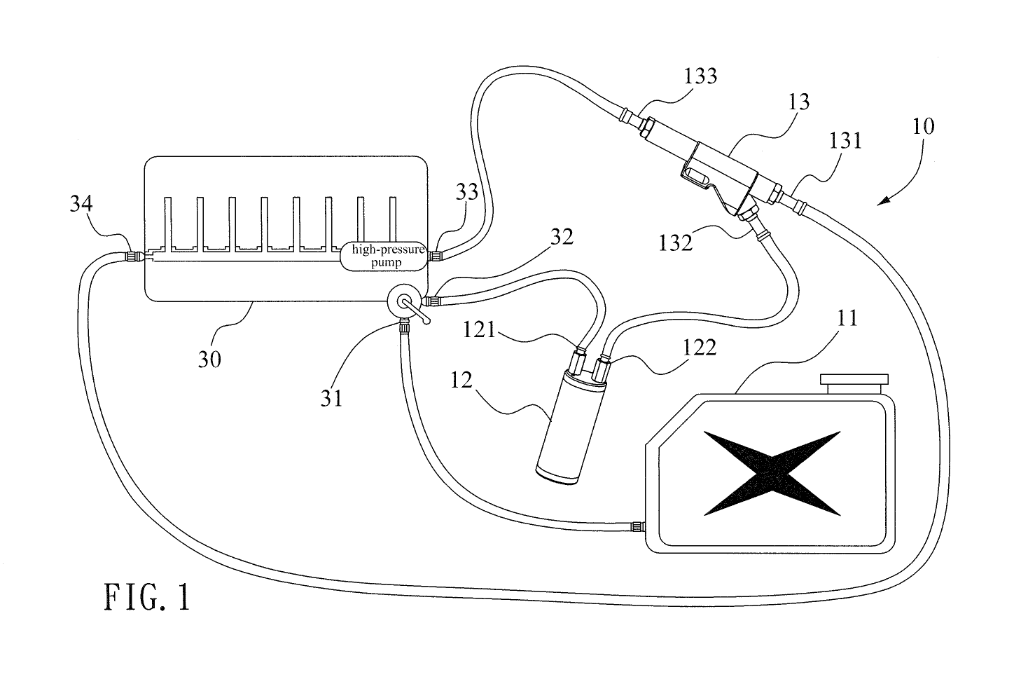

Referring to FIG. 1, which is a schematic view illustrating the relationship of connection of a fuel supply device according to a preferred embodiment of the present invention, the fuel supply device 10 is fit to supply a fuel that is necessary for engine power of for example a diesel engine 30. As shown in the drawing, the diesel engine 30 comprises a hand-operating pump inlet 31, a hand-operating pump outlet 32, a high-pressure pump fuel inlet port 33, and a fuel return port 34. The fuel supply device 10 comprises a fuel tank 11, a filter can 12, and a fuel-returning three-way pipe 13 that are interconnected with each other.

The fuel tank 11 is connected to the hand-operating pump inlet 31 of the diesel engine 30 and functions to store therein the fuel necessary for the engine power. The filter can 12 comprises an inlet opening 121 and an outlet opening 122. The inlet opening 121 is connected to the hand-operating pump outlet 32 of the diesel engine 30. The fuel-returning three-way pipe 13 comprises a priority terminal 131, a slope terminal 132, and a discharge terminal 133. The priority terminal 131 is connected to the fuel return port 34 of the diesel engine 30. The slope terminal 132 is connected to the outlet opening 122 of the filter can 12. The discharge terminal 133 is connected to the high-pressure pump fuel inlet port 33 of the diesel engine 30 to conduct heated fuel from the fuel return port 34 of the engine through the discharge terminal 133 for supply, with priority, to the diesel engine 30 for combustion therein in order to save energy and effectively improve the operation performance of the engine.

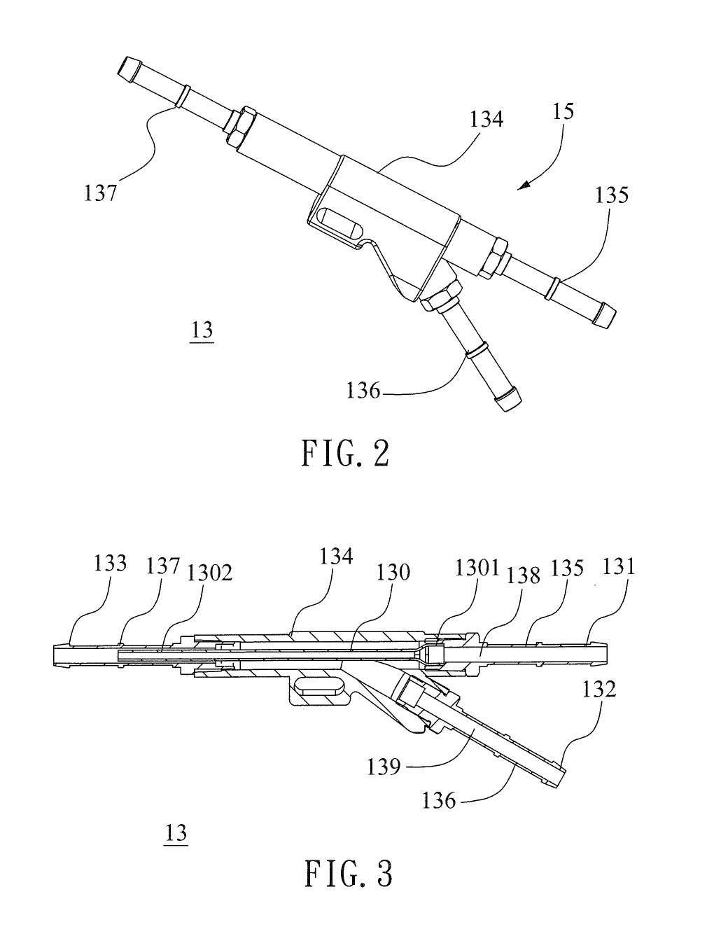

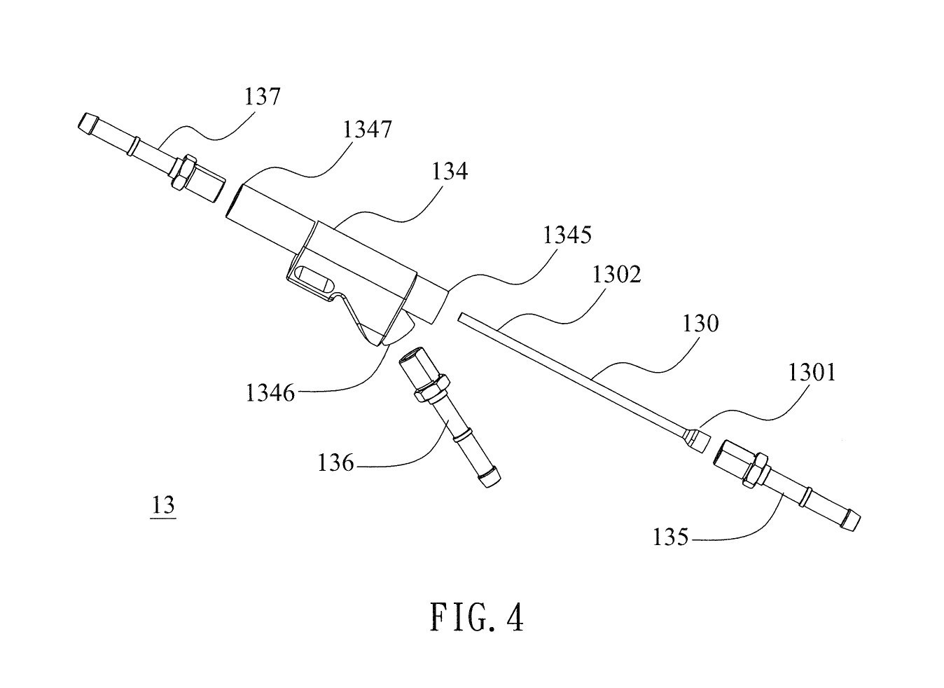

Referring to FIGS. 2-4, which are respectively a perspective view, a cross-sectional view, and an exploded view of the fuel-returning three-way pipe 13 shown in FIG. 1. As shown in these drawings, the fuel-returning three-way pipe 13 comprises a three-way pipe body 15 that is made up of a Y-shaped body 134 and three pipe fittings 135, 136, 137 and a core fitting 130.

The Y-shaped body 134 comprises a first end 1345, a second end 1346, and a third end 1347. The three pipe fittings 135, 136, 137 are respectively connected, through mated internal and external threads (not shown), to the first end 1345, the second end 1346, and the third end 1347 of the Y-shaped body 134 to form the priority terminal 131, the slope terminal 132, and the discharge terminal 133 of the three-way pipe body 15 of the fuel-returning three-way pipe 13.

As shown in FIGS. 2 and 3, a straight passage 138 is provided between the priority terminal 131 and the discharge terminal 133 of the three-way pipe body 15. The slope terminal 132 forms a slope passage 139 that forms an included angle of 36-90 degrees with respect to the straight passage 138. Further, the core fitting 130 comprises a connection end 1301 and a passage end 1302. The connection end 1301 is inserted into and connected with the priority terminal 131 of the three-way pipe body. The passage end 1302 has an outside diameter that is smaller than an inside diameter of the straight passage 138 and the passage end 1302 extends, in a direction towards the discharge terminal 133 of the three-way pipe body 15, beyond the slope passage 139 of the slope terminal 132 to allow the returned heated fuel from the priority terminal 131 to be supplied, with higher priority than fuel supplied from the slope terminal 132, to the diesel engine 30 for combustion to provide the power of the diesel engine 30.

In the instant embodiment, to prevent the fuel or the returned heated fuel from forming turbulences in the three-way pipe body 15 and thus affecting smooth supply of fuel, the passage end 1302 of the core fitting 130 is further extended into the pipe fitting 137 of the third end 1347 of the Y-shaped body 134, whereby a flow channel arrangement including an inner core channel and an outer annular channel is formed in the pipe fitting 137 to respectively conduct the returned heated fuel and the fuel directly from the fuel tank 11 to smoothly pass therethrough.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fuel supply device, which is adapted to supply a fuel necessary for power of an engine, wherein the engine comprises a hand-operating pump inlet, a hand-operating pump outlet, a high-pressure pump fuel inlet port, and a fuel return port, the fuel supply device comprising:
a fuel tank, which is connected to the hand-operating pump inlet and is adapted to store therein the fuel;
a filter can, which comprises an inlet opening and an outlet opening, the inlet opening being connected to the hand-operating pump outlet; and
a fuel-returning three-way pipe, which comprises a priority terminal, a slope terminal, and a discharge terminal, the priority terminal being connected to the fuel return port, the slope terminal being connected to the outlet opening of the filter can, the discharge terminal being connected to the high-pressure pump fuel inlet port to supply, with priority, fuel from the fuel return port through the discharge terminal to the engine.

2. The fuel supply device according to claim 1, wherein the fuel-returning three-way pipe comprises:
a three-way pipe body, which comprises the priority terminal, the slope terminal, and the discharge terminal, a straight passage being formed between the priority terminal and the discharge terminal, the slope terminal forming a slope passage that forms an angle with respect to the straight passage; and
a core fitting, which comprises a connection end and a passage end, the connection end being connected to the priority terminal of the three-way pipe body, the passage end having an outside diameter that is smaller than an inside diameter of the straight passage, the passage end being arranged to extend, in a direction toward the discharge terminal, beyond the slope passage.

3. The fuel supply device according to claim 2, wherein the three-way pipe body comprises:
a Y-shaped body, which comprises a first end, a second end, and a third end; and
three pipe fittings, which are respectively connected to the first end, the second end, and the third end to form the priority terminal, the slope terminal, and the discharge terminal of the three-way pipe body.

4. The fuel supply device according to claim 2, wherein the angle formed between the straight passage and the slope passage of the three-way pipe body ranges between 30 and 60 degrees.

5. A fuel-returning three-way pipe, comprising:
a three-way pipe body, which comprises a priority terminal, a slope terminal, and a discharge terminal, a straight passage being formed between the priority terminal and the discharge terminal, the slope terminal forming a slope passage that forms an angle with respect to the straight passage; and
a core fitting, which comprises a connection end and a passage end, the connection end being connected to the priority terminal of the three-way pipe body, the passage end having an outside diameter that is smaller than an inside diameter of the straight passage, the passage end being arranged to extend, in a direction toward the discharge terminal, beyond the slope passage.

6. The fuel-returning three-way pipe according to claim 5, wherein the three-way pipe body comprises:
a Y-shaped body, which comprises a first end, a second end, and a third end; and
three pipe fittings, which are respectively connected to the first end, the second end, and the third end to form the priority terminal, the slope terminal, and the discharge terminal of the three-way pipe body.

7. The fuel-returning three-way pipe according to claim 5, wherein the angle formed between the straight passage and the slope passage of the three-way pipe body ranges between 30 and 60 degrees.
